(19) United States
(12) Patent Application Publication
(10) Pub. No.: US 2004/0020011 A1
(43) Pub. Date: Feb. 5, 2004

(54) Bi-directional hinge

(75) Inventor: Shih-Hao Fang, Taipei (TW)

Correspondence Address: BACON & THOMAS, PLLC, 625 SLATERS LANE, FOURTH FLOOR, ALEXANDRIA, VA, 22314

(73) Assignee: GEE BRIDGE INTERNATIONAL INC., Taipei (TW)

(21) Appl. No.: 10/207,226

(22) Filed: Jul. 30, 2002

(51) Int. Cl. E05F 1/08

(52) U.S. Cl. 16/302

(57) ABSTRACT

A bi-directional hinge has a body with two barrels formed at two sides thereof. The barrels each have a slot defined through an outer periphery and adjacent a top end thereof Two torsional springs are respectively received in the barrels. A first leaf and a second leaf are pivotally mounted on the barrels respectively. Two upper seats are respectively provided on the top ends of the barrels, and two lower seats are respectively provided on the bottom ends of the barrels. Two axles respectively extend through the lower seats, the torsional springs and the upper seats. Two upper caps are provided at upper ends of the axles, and two lower caps are provided at lower ends of the axles. The upper and lower caps have linings of an abrasion-resistant plastic formed therein.

### BACKGROUND OF THE INVENTION

1. Field of the Invention

The present invention is related to a hinge, and more particularly to a bi-directional hinge that has adjustable torsional springs provided therein.

2. Description of Related Art

Bi-directional hinges are used for enabling doors installed thereon to open in two directions.

A conventional bi-directional hinge, as illustrated in FIG. 7, is composed of a body (70), a front leaf (80) and a rear leaf (80′) pivotally mounted on the body (70).

The body (70) has two barrels (72, 72′) formed at two sides thereof. Two upper seats (90) and two lower seats (92) are respectively mounted at top ends and bottom ends of the barrels (72, 72′). Two torsional springs (74′) are respectively received in the barrels (72, 72′), and ends of the torsional springs (74′) are attached to the respective upper seats (90) and lower seats (92). The upper seats (90) each have a first outer flange (900) abutting the top end of the respective barrel (72, 72′), and the lower seats (92) each have a second outer flange (920) abutting the bottom end of the respective barrel (72, 72′). The first outer flange (900) has a plurality of holes (901) evenly and radially defined through an outer periphery thereof, and a pin (91) optionally inserted in one of the holes (901).

The front leaf (80) is composed of two plates substantially perpendicular to each other, wherein a plurality of first openings defined through a first plate for installing on a door, and two first ears (81, 82) are respectively formed at upper and lower ends of the second plate. The rear leaf (80′) has a plurality of second openings defined therethrough for installing on a doorframe, and two second ears (81′, 82′) respectively formed at upper and lower ends thereof.

The body has symmetrical form thereof the following descriptions is based on the part of the respective barrel (72′)

An axle (85′) extends through the upper second ear (81′), the upper seat (900), the torsional spring (74′) in the second barrel (72′), the lower seat (902), and out from the lower second ear (82′). Thus, the second leaf (80′) is pivotally mounted on the body (10). Therefore, an other axle (not shown in Fig.) extends through the upper first ear (81), the upper seat (900), the torsional spring (not shown in Fig.)in the first barrel (72), the lower seat (902), and out from the lower first ear (82). Thus, the first leaf (80) is pivotally mounted on the body (10).

Two upper caps (83, 83′) and two lower caps (84, 84′) are respectively provided at ends of the axles (85, 85′) for fastening the axles (85, 85′) in the barrels (81, 81 ′).

When opening a door where the hinge is installed, the front and rear leaves (80, 80′) are turned, and the axles (85, 85′), the caps (83, 83′, 84, 84′) and the upper seats (90) will be turned along with respective leaves (80, 80′).

However, the pins (91) are continually touching and rubbing edges (800, 800′) of the front and rear leaves (80, 80′) in opening/closing the door, and will be worn down after a certain amount of use. Thus, the torsional springs (74′) will lose their resilient forces, and the axles (85′), the caps (83, 83′, 84, 84′) and the lower seats (92) are loosened and may be disengaged from the barrels (80, 80′), so that the bidirectional hinge fails.

Therefore, the invention provides an improved bi-directional hinge to mitigate and/or obviate the aforementioned problems.

### SUMMARY OF THE INVENTION

The main objective of the invention is to provide a bi-directional hinge of which torsional springs can be adjusted for ensuring that the hinge always has enough resilient force.

Another objective of the invention is to provide a bi-directional hinge of which axles have polygonal parts engaged in lower seats and lower caps for preventing the lower seats and lower caps from loosening and disengaging from the axles.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a bi-directional hinge in accordance with the invention;

FIG. 2 is an exploded perspective view of the bi-directional hinge of FIG. 1;

FIG. 3 is a front view of the bi-directional hinge, sectionally showing a first barrel of the hinge;

FIG. 4 is a top view schematically showing the bi-directional hinge in a status that a door on which the hinge is installed is closed;

FIG. 5 is a top view schematically showing the bi-directional hinge in a status that the door is opened about a second barrel;

FIG. 6 is a top view schematically showing the bi-directional hinge in a status that the door is opened about the first barrel; and

FIG. 7 is a front view of a conventional bi-directional hinge.

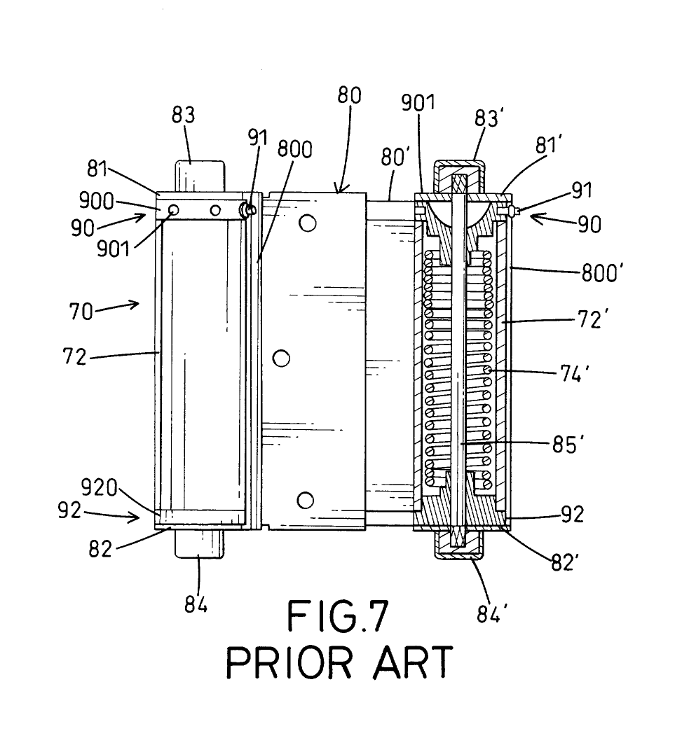

### DETAILED) DESCRIPTION OF THE PREFERRED EMBODIMENT

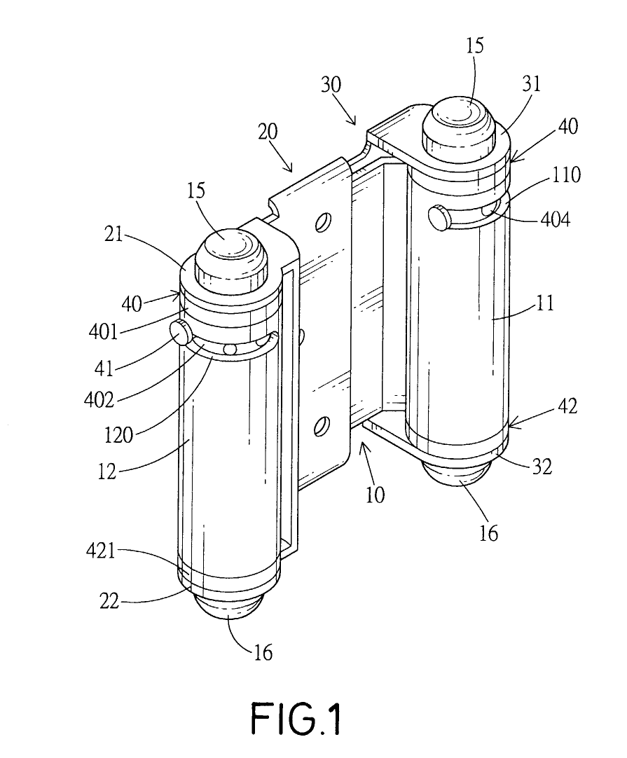

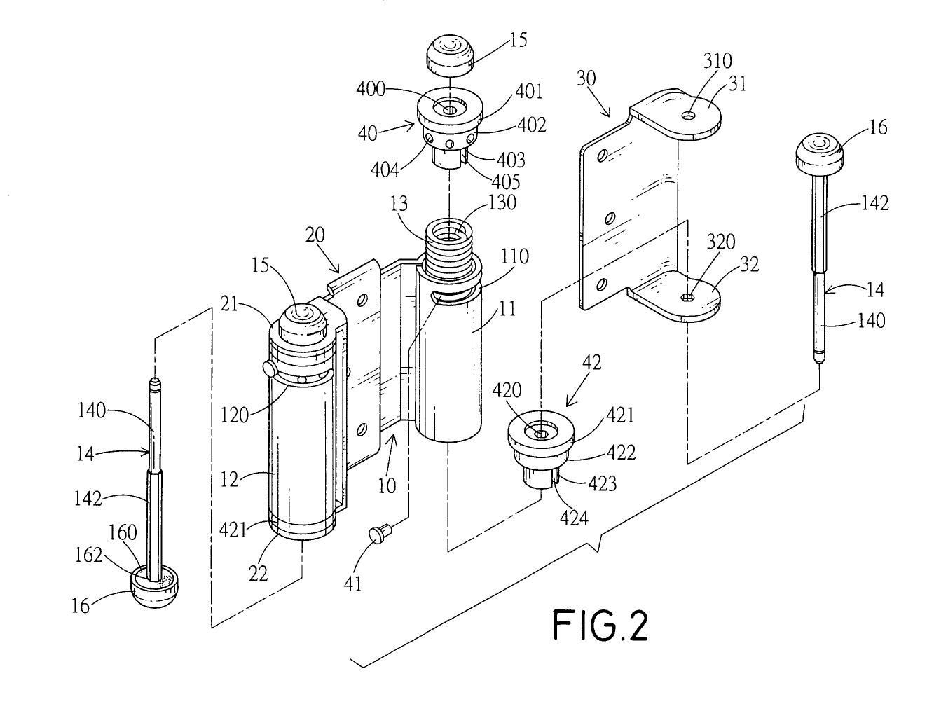

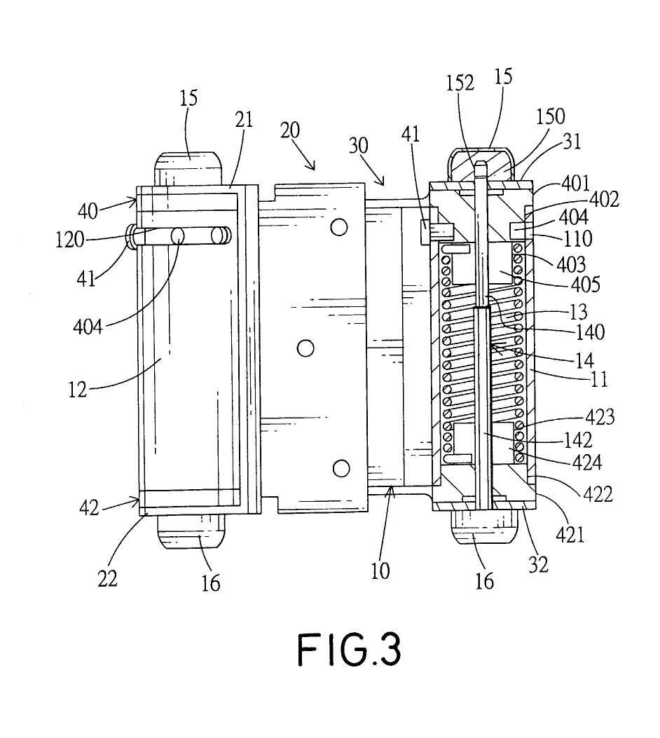

Referring to FIGS. 1-3, a bi-directional hinge in accordance with the invention is composed of a body (10), a first leaf (20) and a second leaf (30) pivotally mounted on the body (10).

The body (10) has two barrels (11, 12) respectively formed on two sides thereof. The barrels (11, 12) each have an arcuate slot (110, 120) transversally defined through an outer periphery thereof and adjacent a top end thereof. Two upper seats (40) are respectively provided on top ends of the barrels (11, 12), and two lower seats (42) are respectively provided on bottom ends of the barrels (11, 12). Two torsional springs (13) are respectively received in the barrels (11, 12). Each of the torsional springs (13) has two attaching ends (130) respectively formed at a top and a bottom thereof and attached to the upper seat (40) and the lower seat (42).

Two axles (14) extend through the barrels (11, 12), the torsional springs (13), and the upper and lower seats (40, 42). Each of the axles (14) has an upper part (140) of which a section is circular, and a lower part (142) of which a section is polygonal. Two upper caps (15) are respectively secured on upper ends of the axles (14), and each has a first lining (150) with a circular hole (152) formed therein for receiving the upper end of the respective axle (14). Two lower caps (16) are respectively secured on lower ends of the axles (14), and each has a second lining (160) with a polygonal hole (162) formed therein for receiving the lower end of the respective axle (14). The linings (150, 160) are made up of an abrasion-resistant plastic.

The first leaf (20) is composed of two plates (not numbered) substantially perpendicular to each other, wherein a plurality of first openings (not numbered) is defined through a first plate for installing on a door, and two first ears (21, 22) are respectively formed at upper and lower ends of the second plate.

The body has symmetrical form thereof the following descriptions is based on the part of the respective barrel (11). The second leaf (30) has a plurality of second openings (not numbered also) defined therethrough for installing on a doorframe. Two second ears (31, 32) are formed on the upper and lower ends of the second leaf (30), and pivotally mounted on the first barrel (11), wherein the upper second ear (31) abuts a top surface of the upper seat (40) and has a second circular aperture (310) defined therethrough for receiving the upper part (140) of the axle (14), and the lower second ear (32) abuts a bottom surface of the lower seat (42) and has a second polygonal aperture (320) for receiving the lower part (142) of the axle (14).

The first ears (21, 22) are pivotally mounted on the second barrel (12), wherein the upper first ear (21) abuts a top surface of the upper seat (40) and has a first circular aperture (not shown or numbered) defined therethrough for receiving the upper part (140) of the axle (14), and the lower first ear (22) abuts a bottom surface of the lower seat (42) and has a first polygonal aperture (not shown or numbered also) for receiving the lower part (142) of the axle (14).

The upper seat (40) has a circular passage (400) defined therethrough for receiving the respective upper part (140). The upper seat (40) is composed of a first outer portion (401), a first middle portion (402), and a first inner portion (403) with stepped diameters, wherein an outer diameter of the first outer portion (401) is the largest, an outer diameter of the first inner portion (403) is the smallest, and an outer diameter of the first middle portion (402) is smaller than that of the first outer portion (401) but larger than that of the first inner portion (403). A plurality of adjusting holes (404) is evenly and radially defined at an outer periphery of the first middle portion (402). The adjusting holes (404) are aligned with the respective slots (110, 120). A first notch (405) is longitudinally defined through the first inner portion (403). The upper attaching ends (130) are attached in the first notches (405). Two pins (41) are respectively inserted through the slots (110, 120) and in one of the adjusting holes (404).

The lower seat (40) has a polygonal passage (420) defined therethrough for receiving the respective lower part (142). The lower seat (40) is composed of a second outer portion (421), a second middle portion (422), and a second inner portion (423) with stepped diameters, wherein an outer diameter of the first outer portion (401) is the largest, an outer diameter of the first inner portion (403) is the smallest, and an outer diameter of the first middle portion (402) is smaller than that of the first outer portion (401) but larger than that of the first inner portion (403). A second notch (424) is longitudinally defined through the second inner portion (423). The lower attaching ends (130) are attached in the second notches (405).

In assembling, the torsional springs (13) are first received in the barrels (11, 12). The upper seats (40) and lower seats (42) are respectively mounted on the ends of the barrels (11, 12), and the attaching ends (130) of the torsional springs (13) are respectively attached to the notches (405, 424). The first leaf (20) and the second leaf (30) are respectively disposed on the barrels (11, 12) with ears (21, 22, 31, 32) abutting the respective seats (40, 42).

The axles (14), of which the lower parts (142) are respectively positioned in the polygonal holes (162) of the lower caps (16), are extended from the lower ends through the barrels (11, 12) and the respective ears (21, 22,31,32). The upper caps (15) then are respectively engaged on the upper parts (140) of the axles (14). The pins (41) are optionally inserted in the respective adjusting holes (404) in alignment with the slots (110, 120). Therefore, the leaves (20, 30) are pivotally mounted on the body (10).

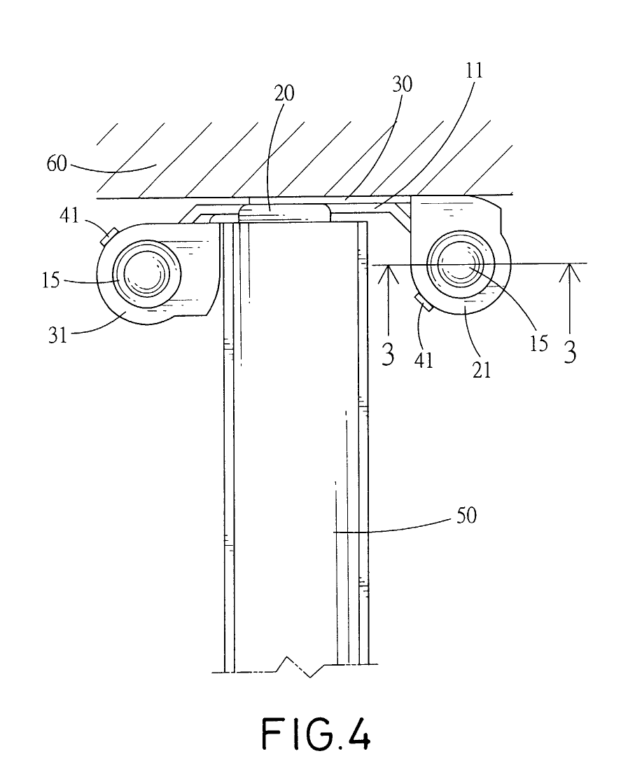

Referring to FIG. 4, the first leaf (20) is mounted on a door (50), and the second leaf (30) is mounted on a doorframe (60).

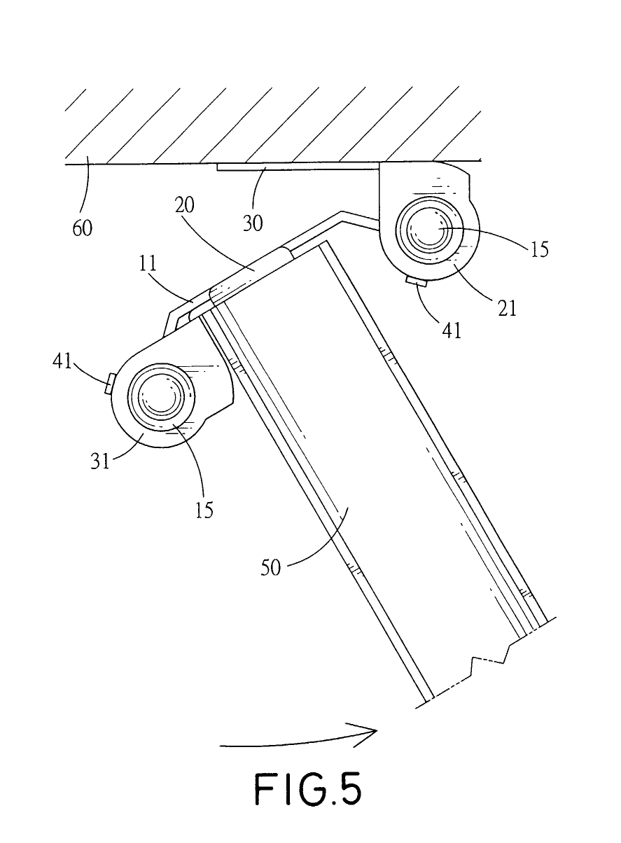

When the door (50) is opened as shown in FIG. 5, the door (50) with the body (10) is pivoted about the stationary second leaf (30) on the doorframe (60). Because the lower part (142) of the axle (14) in the first barrel (11) is inserted through the polygonal aperture (320), the axle (14) is stationary in respect to the second leaf (30). Thus, the lower seat (42) and the lower cap (16) of the first barrel (11) are also stationary. Because the pin (41) is inserted in the adjusting hole (404), the upper seat (40) along with the first barrel (11) is turned about the axle (14), and the torsional spring (13) in the first barrel (11) is twisted. Under the resilient force of the torsional spring (13), the door (50) can automatically return to the original position when an external force to open the door (50) is released.

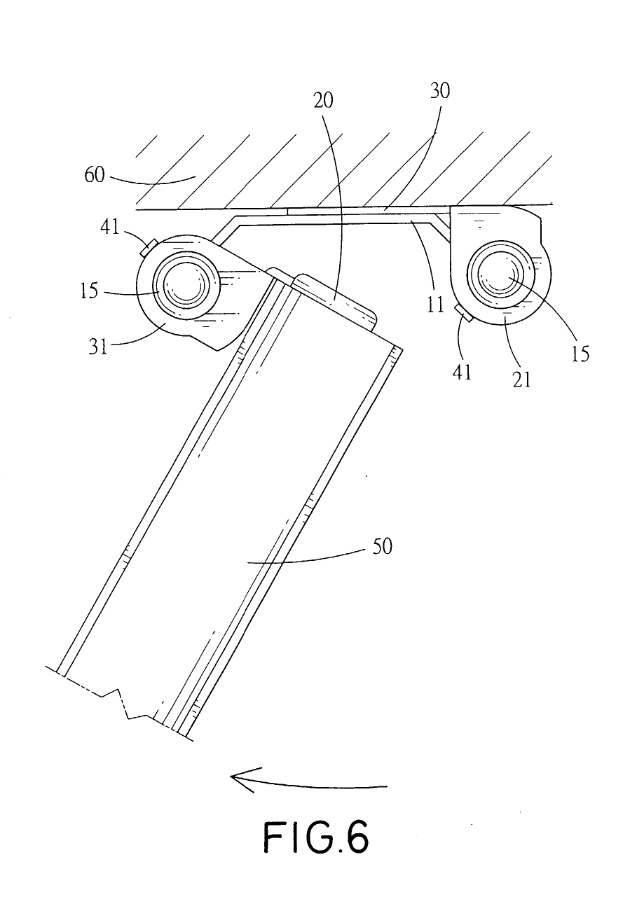

When the door (50) is opened as shown in FIG. 6, the door (50) with the first leaf (20) is pivoted about the stationary the second barrel (12) of the body (10). Because the lower part (142) of the axle (14) in the second barrel (12) is inserted through the polygonal aperture (220), the axle (14) is turned along with the first leaf (20). Thus, the lower seat (42) and the lower cap (16) of the second barrel (11) are also turned along with the first leaf (20). Because the pin (41) is inserted in the adjusting hole (404), the upper seat (40) in the second barrel (12) is stationary in respect to the body (10), and the torsional spring (13) in the second barrel (12) is twisted. Under the resilient force of the torsional spring (13), the door (50) can automatically return to the original position when an external force to open the door (50) is released.

From the above description, it is noted that the invention has the following advantages:

1. The pins can be optionally inserted in one of the adjusting holes, so that it is very easy to adjust the torsional springs to ensure that the hinge has enough resilient forces to close the door.

2. The axles have polygonal lower parts to prevent the lower caps and the lower seats disengaging from the axles.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A bi-directional hinge comprising:
a body (10), the body (10) having two barrels (11, 12) respectively formed at two sides thereof, two arcuate slots (110, 120) respectively and transversally defined through outer peripheries of the barrels (11, 12) and adjacent top ends of the barrels (11, 12), and two torsional springs (13) respectively received the barrels (11, 12) and each having two attaching ends (130) respectively formed at a top and a bottom thereof;
two upper seats (40) respectively provided at the top ends of the barrels (11, 12), each upper seat (40) having a circular passage (400) defined therethrough, a first outer portion (401) abutting a top end of the respective barrel (11, 12), a first middle portion (402), of which an outer diameter is smaller than that of the first outer portion (401), formed under the first outer portion (401) and received in the respective barrels (11, 12) and having a plurality of adjusting holes (404) evenly and radially define through the first middle portion (402) and in alignment with the respective slot (110, 120), and a pin (41) optionally inserted in one of the adjusting holes (401), and a first inner portion (403), of which an outer diameter is smaller than that of the first middle portion (402), formed under the first middle portion (402) and having a first notch (405) longitudinally defined through the first inner portion (403), the upper attaching ends (130) of the torsional springs (13) attached to the respective first notch (405);
two lower seats (42) respectively provided at the bottom ends of the barrels (11, 12), each lower seat (40) having a polygonal passage (420) defined therethrough, a second outer portion (421) abutting the bottom end of the respective barrel (11, 12), a second middle portion (422), of which an outer diameter is smaller than that of the second outer portion (421), formed above the second outer portion (421) and received in the respective barrel (11, 12), and a second inner portion (423), of which an outer diameter is smaller than that the second middle portion (422), formed above the second middle portion (422) and having a second notch (424) longitudinally defined through the first inner portion (403), the lower attaching ends (130) of the torsional springs (13) attached to the respective second notch (424);
a first leaf (20) pivotally mounted on the second barrel (12), the first leaf (20) having a first upper ear (21) abutting the upper seat (40) on the second barrel (12) and having a first circular aperture defined through the first upper ear (21), and a first lower ear (22) abutting the lower seat (42) on the second barrel (12) and having a first polygonal aperture (220) defined through the first lower ear (22);
a second leaf (30) pivotally mounted on the first barrel (11), the second leaf (30) having a second upper ear (31) abutting the upper seat (40) on the first barrel (11) and having a second circular aperture (310) defined through the second upper ear (31), and a second lower ear (32) abutting the lower seat (42) on the first barrel (11) and having a second polygonal aperture (320) defined through the second lower ear (22);
two axles (14) respectively extending through the barrels (11, 12), each axle (14) having an upper part (140), of which a section is circular, inserted through the respective circular passage (400) of the upper seats (40) and the respective circular aperture (310) of the upper ears (21, 31), and a lower part (142), of which a section is polygonal, inserted through the respective polygonal passage (420) of the lower seats (42) and the respective polygonal aperture (220, 320) of the lower ears (22, 32);
two upper caps (15) respectively provided at upper ends of the axles (14); and
two lower caps (16) respectively provided at lower ends of the axles (14).

2. The bidirectional hinge as claimed in claim 1, wherein the upper caps (15) each have a first lining (150) with a circular hole (152) formed therein, and the upper ends of the axles (14) are engaged in the respective circular hole (152).

3. The bi-directional hinge as claimed in claim 1, wherein the lower caps (16) each have a second lining (160) with a polygonal hole (162) formed therein, and the lower ends of the axles (14) are engaged in the respective polygonal hole (162).

4. The bi-directional hinge as claimed in claim 2, wherein the first lining (150) is made up of an abrasion-resistant plastic.

5. The bi-directional hinge as claimed in claim 3, wherein the second lining (160) is made up of an abrasion-resistant plastic.
